(19) United States
(12) Patent Application Publication
(10) Pub. No.: US 2021/0356445 A1
(43) Pub. Date: Nov. 18, 2021

(54) GATEWAY DEVICE, MONITORING SYSTEM, DATA CONVERSION METHOD, AND PROGRAM FOR CAUSING COMPUTER TO EXECUTE DATA CONVERSION METHOD

(71) Applicant: Shimadzu Corporation, Kyoto (JP)

(72) Inventor: Takeshi YOSHIDA, Kyoto (JP)

(21) Appl. No.: 17/277,237

(22) PCT Filed: Sep. 21, 2018
(86) PCT No.: PCT/JP2018/035148

§ 371 Date: Mar. 17, 2021

(51) Int. Cl. G01N 30/86; G01N 1/10

(52) U.S. Cl. CPC G01N 30/8631; G01N 2030/027; G01N 1/10

(57) ABSTRACT

A gateway device (GW) is configured to collect data from one or a plurality of weight sensors (51, 52) installed on a monitoring target device (100) and transmit the collected data to a server. The gateway device (GW) includes a data receiving unit (112) for receiving weight data monitored by one or a plurality of weight sensors (51, 52), a storage device (116) for accumulating weight data, an arithmetic processing unit (114) for converting the weight data to an actual operation time of the monitoring target device based on a conversion rule indicating a relation between an operation time of the monitoring target device (100) and a change amount of weight data, and a data transmission unit (118) for transmitting the actual operation time to the server in a cloud.

### TECHNICAL FIELD

The present invention relates to a gateway device for processing to obtain an actual operation time of a monitoring target device, such as, e.g., an analytical instrument. It also relates to a monitoring system, a data conversion method, a data conversion method, and a program for causing a computer to execute the data conversion method.

### BACKGROUND OF THE INVENTION

Japanese Unexamined Patent Application Publication No. 2004-70424 (Patent Document 1) describes an operation information collection system for a machine tool. This operation information collection system of a machine tool measures the operation signal which specifies the operation state of the machine tool in real time, determines the operation state by the category on the operation signal by comparing with the determination criteria, and stocks the determination result as the operation information by each category.

As described above, there is a need to automatically acquire the operation state of a facility, such as, e.g., a machine tool, collect the operation data result and accumulate basic data for a cost calculation, productivity improvement, new introduction of a facility, and planning of a renewal plan.

### PRIOR ART DOCUMENT

Patent Document
Patent Document 1: Japanese Unexamined Patent Application Publication No. 2004-70424

### SUMMARY OF THE INVENTION

### Problems to be Solved by the Invention

Equipment requiring a grasp of an operation status of a facility includes an analytical instrument, such as, e.g., a chromatograph. There are cases where a large number of chromatographs are operated in a laboratory of a company or the like. In some cases, these chromatographs include those made by a plurality of manufacturers, and there may be some devices that cannot obtain an operation signal as in the above-described Japanese Unexamined Patent Application Publication No. 2004-70424.

It is conceivable that sensors are attached to monitoring target devices to transmit the data of the sensors to a monitoring point for determination, but the operating points may be divided into a plurality of portions or may be remote places. Therefore, it is required to reduce communication costs by reducing the communication data.

It is an object of the present invention to provide a gateway device capable of being easily installed on various devices and suppressing communication costs of a data collection, and also to provide a monitoring system, a data conversion method, and a program for causing a computer to execute the data conversion method.

### Means for Solving the Problem

In summary, the present invention relates to a gateway device configured to collect data from one or a plurality of weight sensors installed on a monitoring target device and transmit the collected data to a server, the gateway device includes a data receiving unit, a storage device, an arithmetic processing unit, and a data transmission unit. The data receiving unit is configured to receive weight data monitored by the one or the plurality of weight sensors. The storage device is configured to accumulate the weight data. The arithmetic processing unit is configured to convert the weight data into an actual operation time of the monitoring target device based on a conversion rule indicating a relation between an operation time of the monitoring target device and a change amount of the weight data. The data transmission unit is configured to transmit the actual operation time to the server.

Preferably, the storage device is configured to store the conversion rule. The conversion rule includes an identifier of a sensor used to measure a weight that varies in conjunction with the operation time of the monitoring target device out of identifiers (ID) of the one or the plurality of weight sensors. The identifier of the sensor used is rewritable.

Preferably, the storage device is configured to store the conversion rule. The conversion rule includes a determination threshold of a change amount of the weight for calculating the operation time of the monitoring target device. The determination threshold is rewritable.

Preferably, the monitoring target device is a liquid chromatograph and the one or the plurality of weight sensors are arranged to measure the weight of a container accommodating a mobile phase

Preferably, the monitoring target device is a liquid chromatograph, and the one or the plurality of weight sensors are arranged to measure the weight of a container accommodating a waste liquid of a mobile phase after use.

According to another aspect, the present invention relates to a monitoring system equipped with any one of the above-described gateway devices.

According to still another aspect, the present invention relates to a data conversion method in a gateway device configured to collect data from one or a plurality of weight sensors installed on a monitoring target device and transmit the collected data to a server. The data conversion method includes: a step of receiving weight data monitored by the one or the plurality of weight sensor; a step of accumulating the weight data; a step of converting the weight data into an actual operation time of the monitoring target device based on a conversion rule indicating a relation between an operation time of the monitoring target device and a change amount of the weight data; and a step of transmitting the actual operation time to the server.

According to still yet another aspect, the present invention relates to a program that causes a computer to execute the above-described data conversion method.

### Effects of the Invention

According to the present invention, it is possible to calculate an accurate operation rate taking into account of the relation between the weight change of a mobile phase and the operation time which differ from one device to another. By modifying the program of the gateway device, it is possible to cope with various models and usage modes. Further, the communication traffic volume between the server on the cloud and the gateway device can be reduced.

### BRIEF DESCRIPTION OF THE DRAWINGS

FIG. 1 is a block diagram showing a configuration of a liquid chromatograph to which the gateway device according to an embodiment of the present invention is applied.

FIG. 2 is a side view of a tray accommodating mobile phase bottles.

FIG. 3 is a top view of the tray accommodating the mobile phase bottles.

FIG. 4 is a block diagram showing a configuration of a monitoring system according to the embodiment of the present invention.

FIG. 5 is a graph showing a change in a measured value of a weight sensor when an isocratic analysis is performed.

FIG. 6 is a graph showing a change of a measured value of the weight sensor when a binary gradient analysis is performed.

FIG. 7 is a block diagram showing a configuration of a gateway device GW.

FIG. 8 is a flowchart schematically showing the processing performed by the gateway device GW.

FIG. 9 is a diagram showing the contents of data held in a residual meter, a gateway device, and a server in a cloud.

FIG. 10 is a flowchart showing in detail the processing performed by the gateway device GW.

### EMBODIMENTS FOR CARRYING OUT THE INVENTION

Embodiments of the present invention will be described in detail with reference to the drawings. The same or corresponding portions in the drawings are denoted by the same reference numerals, and the description thereof will not be repeated.

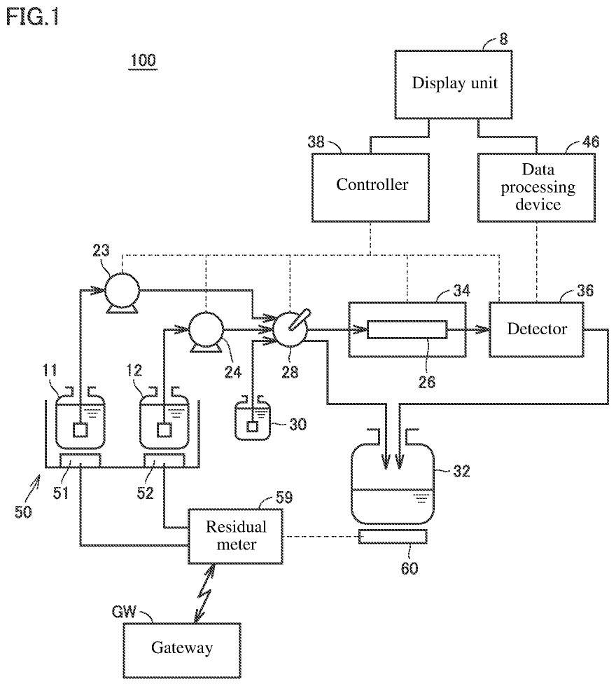

FIG. 1 is a block diagram showing a configuration of a liquid chromatograph to which a gateway device according to the embodiment of the present invention is connected.

The liquid chromatograph 100 is provided with liquid feeding pumps 23 and 24, an autosampler 28, a column oven 34 for warming a separation column 26, a detector 36, a controller 38, a data processing device 46, and a display unit 8.

The liquid chromatograph 100 is provided with a tray 50 for accommodating mobile phase bottles 11 and 12. The mobile phases from the mobile phase bottles 11 and 12 are fed to the separation column 26 by the liquid feeding pumps 23 and 24, respectively. The flow path between the liquid feeding pump 23, 24 and the separation column 26 is provided with the autosampler 28 for introducing a sample into the mobile phase. A flow path from a cleaning solution bottle 30 is connected to the autosampler 28. The discharge flow path for the cleaning liquid from the autosampler 28 is connected to a drain bottle 32 for storing a waste liquid. The separation column 26 is stored in the column oven 34 and maintained at a constant temperature. The detector 36 for detecting sample components separated by the separation column is provided at the flow path outlet of the separation column 26. The waste liquid of the mobile phase from the detector 36 is also stored in the drain bottle 32.

The liquid feeding pump 24, the autosampler 28, the column oven 34, and the detector 36 are connected to the controller 38, and each operation is controlled by the controller 38. Although not shown, the controller 38 is constituted by a CPU, a ROM in which an operation program is stored, and a RAM that temporarily stores an analysis program, a mobile phase amount integrated value, and a cleaning liquid integrated value, and the like. The detection signals from the detector 36 are transmitted to the data processing device 46 for identification and quantification of detected peaks. The controller 38 and the data processing device 46 are connected to the display unit 8.

The operation of the sample analysis according to the liquid chromatograph 100 will be described. The separation column 26 is installed in the column oven 34 and connected to the flow path. By the controller 38, the liquid feeding pumps 23 and 24 are driven to feed the mobile phases to the separation column 26. After the column oven 34 is warmed to maintain the separation column 26 at a constant temperature and the detection signal from the detector 36 is stabilized, the autosampler 28 is driven by the controller 38 to inject the sample into the flow path. The injected sample is separated by the separation column 26 and the separated components are detected by the detector 36. The detected signals from the detector 36 are transmitted to the data processing device 46 for identification and quantification of the separated components. In the autosampler 28, in order to prevent contamination between samples, an operation of sucking the cleaning liquid from the cleaning solution bottle 30 and cleaning the inside of the flow path is performed for each injection of the sample. The used mobile phase discharged from the detector 36 and the used cleaning liquid discharged from the autosampler 28 are stored as a waste liquid in the drain bottle 32.

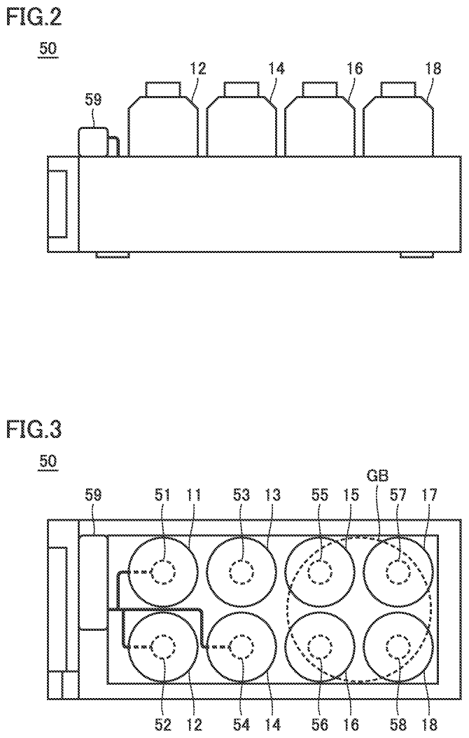

FIG. 2 is a side view of a tray accommodating the mobile phase bottles. FIG. 3 is a top view of the tray accommodating the mobile phase bottles. With reference to FIG. 1 to FIG. 3, weight sensors 51 to 58 for weighing the mobile phase bottles 11 to 18, respectively, are arranged at the bottom of the tray 50. The weight sensors 51 to 58 output the measured weight data to a residual meter 59.

In cases where a large-capacity bottle, such as, e.g., a gallon bottle, is accommodated in the tray, one large-capacity bottle may be placed on top of the several weight sensors 55 to 58, and the detected total weight of the weight sensors 55 to 58 may be treated as the weight of the large-capacity bottle, as shown in the dashed-line GB in FIG. 3.

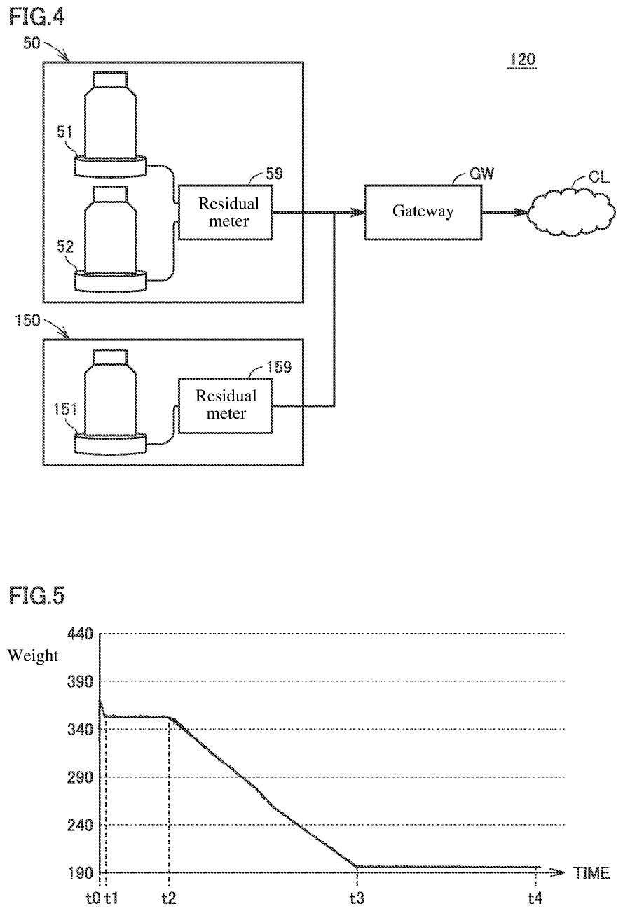

FIG. 4 is a block diagram showing a configuration of a monitoring system of this embodiment. The monitoring system 120 includes weight sensors 51 and 52 accommodated in a tray 50, a residual meter 59 for receiving the measurement data from the weight sensors 51 and 52, a weight sensor 151 accommodated in a tray 150, a residual meter 159 for receiving the measurement data from the weight sensor 151, a gateway device GW, and a server CL in a cloud.

The gateway device GW receives the data measured by the weight sensors 51, 52, and 151 from the residual meters 59 and 159. The tray 50 and the tray 150 may be arranged in the same liquid chromatograph or may be arranged in separate liquid chromatographs.

The monitoring system 120 calculates the actual operation time of the liquid chromatograph by monitoring the remaining amount of the mobile phases in the mobile phase bottles of the trays 50 and 150 arranged in the liquid chromatograph with the weight sensors 51, 52, and 151. However, there are various types of apparatuses and there is a plurality of analysis methods. Therefore, the relation between the weight change of the mobile phase bottle and the operation time may be different for each device to be monitored. For this reason, the change amount of the weight detected by the weight sensors cannot be simply converted into the operation time.

Further, it may be considered such that all of the detection data of the weight sensors is transmitted to the server CL in the cloud and collectively determine the actual operation time in the server CL in the cloud. However, in a case where, for example, all of the detection data is transmitted to a server CL in a cloud by using a cellular network, when the communication traffic volume is huge, it is costly.

For this reason, in the monitoring system 120 according to this embodiment, the data from the weight sensor is converted to the actual operation time and the operation state in the gateway device GW, and the data indicating the actual operation time and the operation state is transmitted to the server CL in the cloud, without transmitting the measurement data of the weight sensors to the server CL in the cloud, thereby suppressing the communication traffic volume.

Here are some examples in which the change in the measured value of the weight sensor and the operation time of the device differ for each device will be described.

### Example 1: Cases Where Analysis Type and Bottle Capacity Differ

FIG. 5 is a graph showing the change in the measured value of the weight sensor when an isocratic analysis is performed. In the case of an isocratic analysis, the composition of the mobile phase (a single solvent or a mixed solvent) is not changed during the liquid feeding. FIG. 5 shows the weight change of the mobile phase bottle when the single solvent is a mobile phase.

At the time between t0 and t1 and the time between t2 and t3, the weight of the mobile phase bottle is decreased, indicating that the liquid chromatograph is in operation. On the other hand, at the time between t1 and t2 and the time between t3 and t4, there is no change in the weight of the mobile phase bottle, indicating that the liquid chromatograph is not in operation.

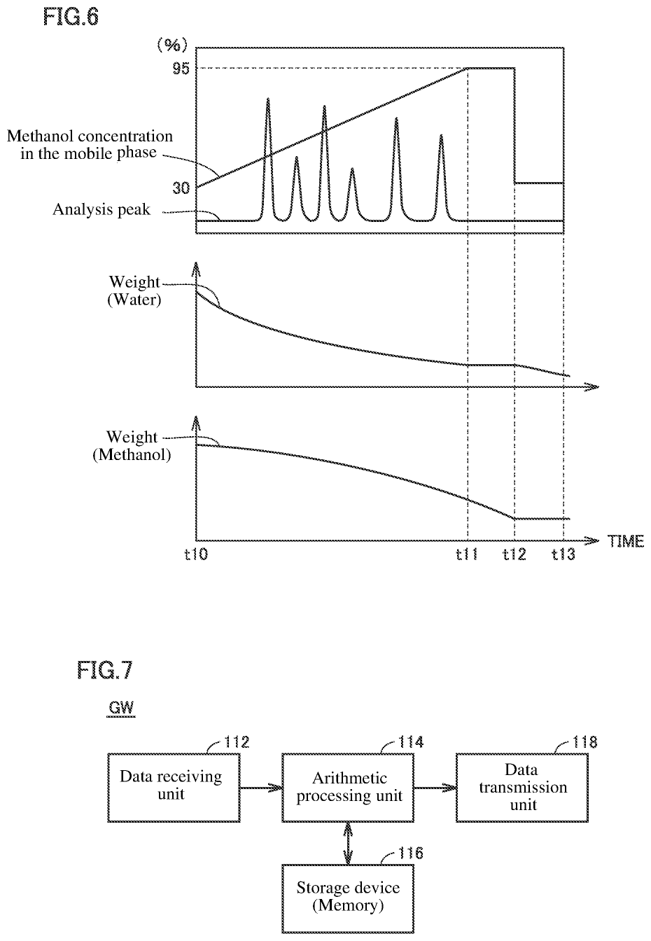

FIG. 6 is a graph showing the change in the measured value of the weight sensor when a binary gradient analysis is performed. The binary gradient analysis denotes an analysis method in which elution is performed while continuously changing the mixed composition of two types of mobile phases. In a binary gradient analysis, usually, the amount of solvent which is strong in the solvent power is gradually increased. In FIG. 6, the methanol concentration in the mobile phase is increased gradually from 30% (initial concentration) to 95% (final concentration) at the time between t10 and t11. At the time between t11 and t12, elution is performed with the methanol concentration fixed at 95%. At the times between t12 and t13, a mobile phase is fed again at 30% of the initial concentration for some time to ensure the equilibration time for the next gradient analysis. In this example, by starting from a low methanol concentration and gradually increasing the methanol concentration, it is possible to elute the two latter components quickly while maintaining the separation of the former four components.

When performing such a binary gradient analysis, there are two mobile phase bottles in which the operation time of the liquid chromatograph and the weight change are linked. There is also a liquid chromatograph for performing an analysis in which much more mobile phase bottles are involved. For example, a quaternary system uses a mobile phase in which four liquids are mixed. During such an analysis, the weight decrease amount is not simply proportional to the operation time, but the degree of decrease changes over time.

Further, as a mobile phase bottle, there may be a case in which a large-volume bottle, such as, e.g., a so-called gallon bottle (a three-liter bottle for reagents), is accommodated in a tray. In such cases, one large-capacity bottle should be placed on top of several weight sensors 55 to 58 and the detected sum-weight of the weight sensors 55 to 58 should be treated as the weight of the large-capacity bottle, as shown by the dashed-line GB in FIG. 3.

### Example 2: Case in Which Weight Change Amount of Mobile Phase Differs Depending on Device

There is a case in which the weight change amount of a mobile phase determined to be in operation differs depending on a target device. For example, the mobile phase used amount during the operation differs depending on the target device, such as 1.0 ml per minute for a general-purpose LC (liquid chromatograph), 0.5 ml per minute for an ultra-high-performance LC, and 20 ml to 30 ml per minute for a preparative LC.

A high-speed LC uses less amount of a mobile phase (pressure is high) because the column is thinner than that of a general-purpose LC. Further, in a preparative LC, not only peaks of composition are analyzed but also the extracted ones after separation are returned to a test tube or the like by a fraction collector and used for other analyses or the like. Therefore, the column is large, and the amount of the mobile phase used is large.

### Third Example: Case in Which State to be Determined to be in Operation Differs Depending on User

A threshold for determining whether or not an analyzer is in operation may differ depending on the user. A liquid chromatograph requires a long time to prepare for preliminary analysis, so it is required to keep a minute amount of liquid flowing in preparation for analysis. Depending on the user, the user may wish to put such preparation time in operation time, or conversely, may wish to set the analysis time purely as the operation time.

As described above, the relation between the measured value of the weight sensor and the operation time of the device varies, and therefore it is necessary to devise to convert the relation to the actual operation time in the gateway device GW.

FIG. 7 is a block diagram showing a configuration of the gateway device GW. Referring to FIG. 1 and FIG. 7, the gateway device GW is configured to collect data from the plurality of weight sensors 51 and 52 installed on the liquid chromatograph 100, which is a monitoring target device. The gateway device GW is provided with a data receiving unit 112 for receiving weight data monitored by the plurality of weight sensors 51 and 52, a storage device 116 for storing the weight data, an arithmetic processing unit (CPU) 114, and a data transmission unit 118.

The arithmetic processing unit 114 converts the weight data to an actual operation time of the monitoring target device based on a conversion rule indicating the relation between the operation time of the liquid chromatograph 100 and the change amount of the weight data. The data transmission unit 118 is configured to transmit the actual operation time to a server in a cloud.

The storage device 116 is configured to store the conversion rule. Preferably, the conversion rule includes an ID of the sensor used to measure the weight that varies in conjunction with the operation time of the monitoring target device among the identifiers (hereinafter referred to as “ID”) of the weight sensors 51 to 58. The IDs of the sensors to be used can be rewritten by the server CL in the cloud.

For example, in a case where the liquid chromatograph 100 is a device that performs an isocratic analysis in which the mobile phase is a single-phase, an ID indicating one of the weight sensors 51 to 58 on which a mobile phase bottle to be used is arranged is stored in the storage device 116. Further, for example, in a case where the liquid chromatograph 100 is a device that performs a binary gradient analysis, IDs indicating the two sensors of the weight sensors 51 to 58 on which the mobile phase bottles to be used are arranged are stored in the storage device 116. In a case where a large-capacity bottle is placed on a tray, a plurality of sensor IDs for detecting the weight of the large-capacity bottle is stored in the storage device 116.

Preferably, the conversion rule includes a determination threshold with respect to the change amount of the weight for calculating the operation time of the monitoring target device. The determination threshold can be rewritten by the server in the cloud. The threshold is set to eliminate the measuring errors of the weight sensor and the effects of noise.

An example is described in which for example, the mobile phase used amount during the operation differs between a general-purpose LC, an ultra-high-speed LC, and a preparative LC. Depending on the target device, the determination threshold suitable for the device is stored in the storage device 116. Further, for example, the threshold may be changed depending on whether or not the preparation time for flowing a minute amount of liquid is included in the operation time.

In order to reduce the communication traffic volume and the number of measurements, the operation time in the measurement interval may be calculated by roughening the measurement interval and dividing the amount of reduction in the detected values of the weight sensor by the mobile phase expected usage amount per hour. Also in this case, the mobile phase expected usage amount may be changed depending on the type of device.

Although the above description is directed to the case in which the weight sensor for measuring the weight data is a weight sensor 51, 52 for measuring the weight of the container (mobile phase bottle 11, 12) accommodating the mobile phase, the operation time may be detected by using the data of the weight sensor 60 for measuring the weight of the container (drain bottle 32) accommodating the waste liquid of the used mobile phase.

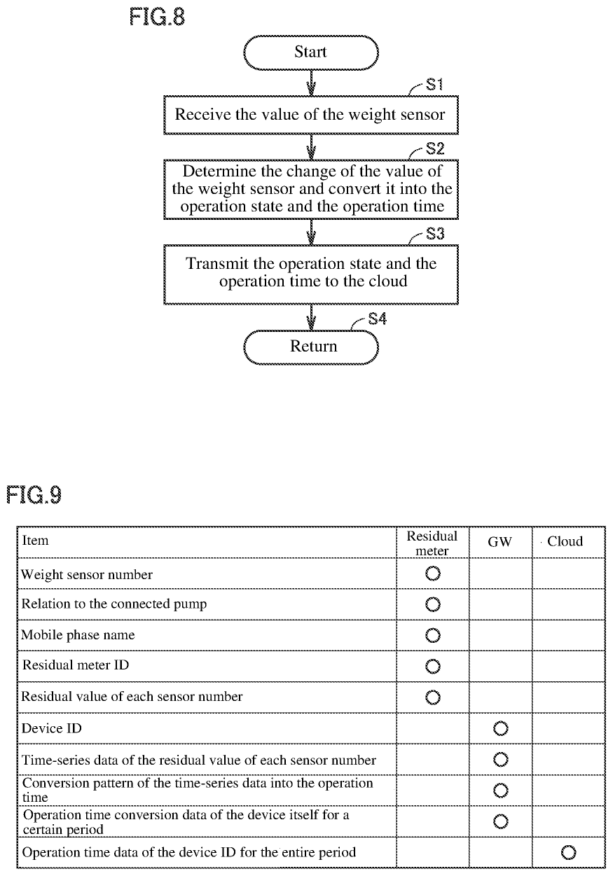

FIG. 8 is a flowchart schematically showing the processing performed by the gateway device GW. In Step S1, the gateway device GW receives the measured value of the one or the plurality of weight sensors. The gateway device GW accumulates the measured values of the weight sensor for a certain period in the storage device 116.

In Step S2, the gateway device GW converts the received data into an appropriate operation state and an actual operation time corresponding to the monitoring target device based on the conversion rule stored in the storage device 116. Although the conversion rule may be fixed, it may be an add-in system so as to be able to cope with various cases at a later time. From the received data, the conversion rule may be automatically estimated and the estimated conversion rule may be store in the storage device 116. The conversion rule stored in the storage device 116 may be updatable by the downloaded distribution from the server CL in the cloud.

In Step S3, the gateway device GW transmits the obtained operation state and the obtained actual operation time to the server CL in the cloud. Some examples of the conversion rule used in Step S2 are described below.

(Case in which Isocratic Analysis is Performed)

In this case, the conversion rule is set so that the state in which the weight value of one sensor is reduced is regarded as the operation state. The threshold determination may be performed by converting the weight reduction value into a flow rate using densities corresponding to room temperatures or mobile phase types.

### (Case of Performing Binary Gradient Analysis, Case of Using Gallon Bottle)

The conversion rule in this case is set such that after calculating the total value or the average value of the measured values of the plurality of sensors, the time during which the calculated value is decreasing is considered as the operation state. Alternatively, since it is common that any mobile phase decreases as the device is in operation, the time at which at least any one sensor value of the plurality of measured values decreases may be considered as the operation time.

(Case in which Flow Rate of Mobile Phase Used for Analysis is Different)

Threshold data according to the type of the system, such as, e.g., a general-purpose LC, an ultra-high-speed LC, and a preparative LC, is prepared, and the threshold is set to the gateway device GW at the time of installation. Alternatively, the threshold may be automatically set by collating the data acquired for a certain period after installation with the operation time acquired by analyzing data or logs reported by the user. Alternatively, the threshold may be automatically set by learning.

In a case where a time, such as, e.g., a preparation time, in which the flow rate is very small, is also set to the operation time, using the data acquired for a predetermined period, the intersection of the slope of the straight line in the period during which the flow rate is slightly decreased and the baseline in the stable period during which the slope is zero is used as the change point of the operation state.

Note that it may be configured such that the threshold value set once is uploaded to the server in the cloud and automatically applied at the time of installation of the same model.

FIG. 9 is a diagram showing the contents of the data held in the residual meter, the gateway device, and the server in the cloud. Referring to FIG. 4 and FIG. 9, in the residual meters 59 and 159, the connected weight sensor number, the relation to the used pump connected to the weight sensor, the name (water, methanol, etc.) of the mobile phase, and the residual meter ID, and the residual values (measured values) of the respective sensor numbers are sequentially inputted.

In the gateway device GW, the device IDs and the conversion pattern (conversion rule) for converting the time-series data into the operation time are stored, and the time-series data of the remaining capacity value of each sensor number is stored. The accumulated time-series data for a certain period is converted into the operation time of the device itself for a certain period. The operation time within a certain period after conversion is transmitted to the server in the cloud, and the server in the cloud accumulates and stores the operation time data for each device ID during the entire period.

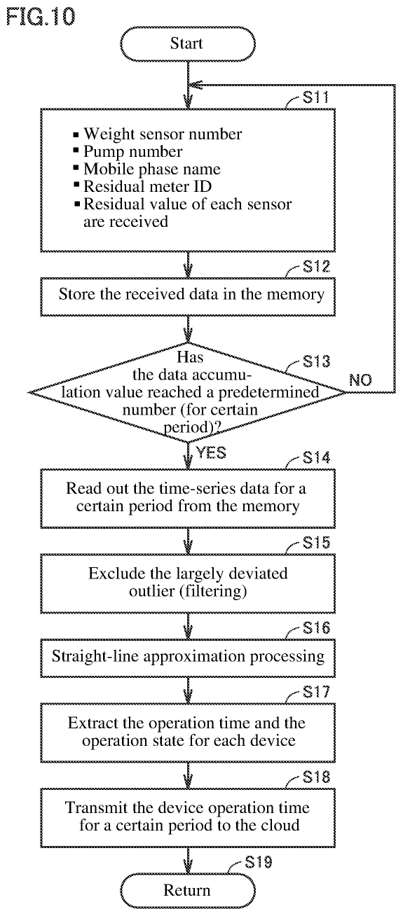

FIG. 10 is a flowchart showing in detail the processing executed by the gateway device GW. Referring to FIG. 10, in Step S11, the gateway device GW receives, from the residual meters 59 and 159, the data in which the weight sensor number, the pump number, the mobile phase name, the residual meter ID, and the residual value of each sensor are combined. In Step S12, the gateway device GW stores the received data in the storage device 116. Subsequently, the gateway device GW determines whether or not the data accumulation amount has reached a predetermined quantity.

When the data accumulation amount has not reached the predetermined quantity (NO in Step S13), the gateway device GW repeats the processing of Steps S11 and S12.

When the data accumulation amount has reached the predetermined quantity (YES in Step S13), the gateway device GW reads the time-series data transmitted from the weight sensors for the predetermined duration from the storage device 116 in Step S14. Then, in Step S15, the outliers greatly deviated are excluded by filtering or the like. in Step S16, the straight-line approximation is performed for each section obtained by subdividing the predetermined period.

Thereafter, in Step S17, the gateway device GW applies the conversion rule to extract the operation states (during the analysis, suspending the analysis, preparation for the analysis, etc.) and the operation time for each device. Then, the gateway device GW transmits the actual operation time of the monitoring target device to the server CL in the cloud for a predetermined period. The server CL in the cloud accumulates the received actual operation times of the monitoring target device for a certain period and notify the user of the actual operation time for the entire period.

As described above, according to this embodiment, it is possible to calculate the accurate operation rate considering the relation between the weight change of the mobile phase and the operation time, which differ for each device. Further, by modifying the program of the gateway device GW, it is possible to cope with various analytical patterns and models. Further, the communication traffic volume between the server on the cloud and the gateway device GW can be reduced.

In the above-described description, the gateway device GW is exemplified. However, an M2M router, etc., is also one kind of a gateway device GW and is covered by the present invention.

Note that a program for causing the arithmetic processing unit 114 to execute the operations shown in this embodiment (processing shown in FIG. 8 and FIG. 10) may be provided. Such a program may also be provided as a computer product by recording on a computer readable recording medium, such as, e.g., a flexible disk, a CD-ROM (Compact Disk-Read Only Memory), a ROM, a RAM, and a memory card. Alternatively, it can be recorded on a recording medium, such as, e.g., a nonvolatile memory built-in a computer, to provide a program. Further, a program may also be provided by downloading via a network.

A program product to be offered is installed in a program storage area of a storage device 116, such as, e.g., a non-volatile memory, and is executed. Note that the program product includes a program itself and the recording medium in which the program is recorded.

The embodiments disclosed herein are to be considered in all respects as illustrative and not restrictive. The scope of the present invention is indicated by the appended claims rather than by the above-described descriptions, and is intended to include all modifications within the meanings and ranges equivalent to the scope of the claims.

### DESCRIPTION OF SYMBOLS

8: Display unit
11, 12, 18: Mobile phase bottle
23, 24: Liquid pump
26: Separation column
28: Autosampler
30: Cleaning solution bottle
32: Drain bottle
34: Column oven
36: Detector
38: Controller
46: Data processing device
50, 150: Tray
51, 52, 55, 58, 60, 151: Weight sensor
59, 159: Residual meter
100: Liquid chromatograph
112: Data receiving unit
114: Arithmetic processing unit
116: Storage device
118: Data transmission unit
120: Monitoring system
CL: Server
GW: Gateway device

1. A gateway device configured to collect data from one or a plurality of weight sensors installed on a monitoring target device and transmit the collected data to a server,
the gateway device comprising:
a data receiving unit configured to receive weight data monitored by the one or the plurality of weight sensors;
a storage device configured to accumulate the weight data;
an arithmetic processing unit configured to convert the weight data into an actual operation time of the monitoring target device based on a conversion rule indicating a relation between an operation time of the monitoring target device and a change amount of the weight data; and
a data transmission unit configured to transmit the actual operation time to the server.

2. The gateway device as recited in claim 1,
wherein the storage device is configured to store the conversion rule,
wherein the conversion rule includes an identifier of a sensor used to measure a weight that varies in conjunction with the operation time of the monitoring target device out of identifiers of the one or the plurality of weight sensors, and
wherein the identifier of the sensor used is rewritable.

3. The gateway device as recited in claim 1,
wherein the storage device is configured to store the conversion rule,
wherein the conversion rule includes a determination threshold to a change amount of the weight for calculating the operation time of the monitoring target device, and
wherein the determination threshold is rewritable.

4. The gateway device as recited in claim 1,
wherein the monitoring target device is a liquid chromatograph, and
wherein the one or the plurality of weight sensors are arranged to measure the weight of a container accommodating a mobile phase

5. The gateway device as recited in claim 1,
wherein the monitoring target device is a liquid chromatograph, and
wherein the one or the plurality of weight sensors are arranged to measure the weight of a container accommodating a waste liquid of a mobile phase after use.

6. A monitoring system equipped with the gateway device as recited in claim 1.

7. A data conversion method in a gateway device configured to collect data from one or a plurality of weight sensors installed on a monitoring target device and transmit the collected data to a server, the data conversion method comprising:
a step of receiving weight data monitored by the one or the plurality of weight sensor;
a step of accumulating the weight data;
a step of converting the weight data into an actual operation time of the monitoring target device based on a conversion rule indicating a relation between an operation time of the monitoring target device and a change amount of the weight data; and
a step of transmitting the actual operation time to the server.

8. A program that causes a computer to execute the data conversion method as recited in claim 7.
